(19) United States
(12) Patent Application Publication
(10) Pub. No.: US 2011/0042618 A1
(43) Pub. Date: Feb. 24, 2011

(54) SYSTEMS AND METHODS FOR HANDLING AND/OR ISOLATING NANOTUBES AND OTHER NANOSTRUCTURES

(75) Inventors: Michael S. Strano, Lexington, MA (US); Woo-Jae Kim, Seoul (KR); Paul W. Barone, Allston, MA (US)

Correspondence Address: WOLF GREENFIELD & SACKS, P.C., 600 ATLANTIC AVENUE, BOSTON, MA, 02210-2206, US

(73) Assignee: Massachusetts Institute of Techonology, Cambridge, MA (US)

(21) Appl. No.: 12/545,787

(22) Filed: Aug. 21, 2009

(51) Int. Cl. D01F 9/12; C09K 3/00; C09K 11/02

(52) U.S. Cl. 252/301.36; 423/447.1; 252/182.32; 977/742; 977/750; 977/752; 977/845

(57) ABSTRACT

Systems and methods related to handling and/or isolating nanotubes and other nanostructures are generally described. In some embodiments, a polymer can be exposed to a collection of agglomerated nanostructures to produce individuated nanostructures. The polymer can comprise one or more pendant groups capable of participating in a pi-pi interaction with at least a portion of the agglomerated nanostructures to produce individuated nanostructures. Individuated nanostructures can be isolated from nanostructures that remain agglomerated. In some cases, individuated nanostructures can be freeze dried to provide, for example, a plurality of nanostructures in solid form. The systems and methods described herein may be so effective in maintaining separation between individuated nanostructures that pluralities of dried nanostructures can be re-suspended in a fluid after they are dried, in some cases with relatively low forces applied during re-suspension.

### GOVERNMENT SPONSORSHIP

This invention was sponsored by NSF Grant No. CBET-0758352, Army Research Office Grant No. W911NF-07-D-0004, and Office of Naval Research Grant No. N00014-09-1-0374. The government has certain rights in the invention.

### FIELD OF INVENTION

Systems and methods for handling and/or isolating nanotubes and other nanostructures are generally described.

### BACKGROUND

A variety of nanostructures have been envisioned for use in industries ranging from structural materials to electronic devices to chemical sensors. When nanostructures are synthesized, they are usually produced as aggregated bundles, rather than collections of individuated nanostructures. However, for many devices the ability to provide individuated nanostructures can be desirable. Thus, systems and methods of obtaining individuated nanostructures, rather than aggregated bundles, would be desirable.

### SUMMARY OF THE INVENTION

The embodiments described herein generally relate to handling and/or isolating nanotubes and other nanostructures. The subject matter of the present invention involves, in some cases, interrelated products, alternative solutions to a particular problem, and/or a plurality of different uses of one or more systems and/or articles.

In one aspect, a method is described. In one set of embodiments, the method comprises a method of isolating individuated nanostructures comprising providing a collection of agglomerated nanostructures, and exposing a polymer capable of participating in a pi-pi interaction with the nanostructures to at least a portion of the agglomerated nanostructures to produce individuated nanostructures and nanostructures that remain agglomerated. The method can further comprise isolating at least a portion of the individuated nanostructures from the nanostructures that remain agglomerated without the use of ultracentrifugation.

In one set of embodiments, the method can comprise providing a collection of agglomerated nanostructures and exposing a polymer capable of interacting with the nanostructures to at least a portion of the agglomerated nanostructures to produce individuated nanostructures and nanostructures that remain agglomerated. In some embodiments, the method further comprises isolating at least 20% of the individuated nanostructures from the nanostructures that remain agglomerated without the use of ultracentrifugation.

In some instances, the method can comprise providing a mixture comprising a fluid and fluorescent nanostructures, and freeze drying the mixture to produce a plurality of individuated nanostructures in indirect solid contact, wherein the individuated nanostructures are fluorescent.

In some cases, the method can comprise providing a mixture comprising a first fluid and nanostructures, and removing at least about 90 wt % of the first fluid from the mixture to produce a plurality of individuated nanostructures in indirect solid contact. The method can further comprise adding the individuated nanostructures in indirect solid contact to a second fluid such that less than about 8% of the nanostructures in the second fluid are in direct contact with another nanostructure.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1C include schematic illustrations illustrating the isolation of nanostructures, according to one set of embodiments;

FIGS. 2A-2F includes UV-vis-nIR absorption spectra of suspended nanostructures, according to one set of embodiments;

FIGS. 3A-3C include exemplary plots of peak maximum-to-valley ratios from absorption spectra of suspended nanostructures as a function of centrifuge speed;

FIGS. 4A-4C include photoluminescence spectra of suspended nanostructures, according to one set of embodiments;

FIGS. 5A-5B include exemplary (A) pictures and (B) UV-vis-nIR spectra of re-suspended nanostructures;

FIGS. 6A-6B include (A) pictures and (B) UV-vis-nIR spectra of re-suspended nanostructures, according to one set of embodiments; and

FIGS. 7A-7B include exemplary fluorescent images of nanostructure films.

### DETAILED DESCRIPTION

Systems and methods related to handling and/or isolating nanotubes and other nanostructures are generally described. In some embodiments, a polymer can be exposed to a collection of agglomerated nanostructures to produce individuated nanostructures. The polymer can comprise one or more pendant groups capable of participating in a pi-pi interaction with at least a portion of the agglomerated nanostructures to produce individuated nanostructures. Individuated nanostructures can be isolated from nanostructures that remain agglomerated. In some cases, individuated nanostructures can be freeze dried to provide, for example, a plurality of nanostructures in solid form. The systems and methods described herein may be so effective in maintaining separation between individuated nanostructures that pluralities of dried or at least partially dried nanostructures can be re-suspended in a fluid after they are dried or at least partially dried, in some cases with relatively low forces applied during re-suspension.

The systems and methods described herein may be useful in a wide variety of fields. For example, individuated nanostructures can be used to make flexible transparent conducting films, sensors (e.g., fluorescent chemical sensors), thin-film transistors, metallic interconnects, and the like. As a specific example, single-walled carbon nanotubes can exhibit fluorescence when they are in an individuated state, but usually exhibit substantially reduced fluorescence (or substantially no fluorescence) when in direct contact with other nanotubes. Thus, the ability to produce individuated nanostructures (e.g., single-walled carbon nanotubes), or to improve the speed or efficiency with which they are produced, can be useful in producing fluorescent nanostructures.

In some embodiments, the ability to isolate individuated nanostructures from a population comprising nanostructures that remain agglomerated is improved after exposure to the conditions described. For example, agglomerated nanostructures may exist where, inherently, prior to the techniques described herein, isolation of individuated nanostructures from agglomerated nanostructures may be possible only after the application of a relatively large force. After exposure to the appropriate conditions, the ability to isolate individuated nanostructures from a population comprising nanostructures that remain agglomerated can improve to the point that isolation can be carried out in a measurable manner, or can be improved to the point that a population of individuated nanostructures can be isolated effectively entirely from another population comprising nanostructures that remain agglomerated by using a relatively small amount of isolating force. In addition, the systems and methods described herein can allow one to maintain isolation of individuated nanostructures after exposure to conditions under which isolation has been traditionally difficult to achieve and/or maintain.

In one aspect, a method of isolating individuated nanostructures is described. As used herein, the term “nanostructure” refers to articles having a fused network of atomic rings, the atomic rings comprising a plurality of double bonds, and at least one cross-sectional dimension of less than about 1 micron. The term “fused network” might not include, for example, a biphenyl group, wherein two phenyl rings are joined by a single bond and are not fused. The term “individuated nanostructure” refers to a nanostructure that is free of direct contact with another nanostructure. As used herein, two articles are in “direct contact” if a line can be drawn that connects the two articles without passing through other matter.

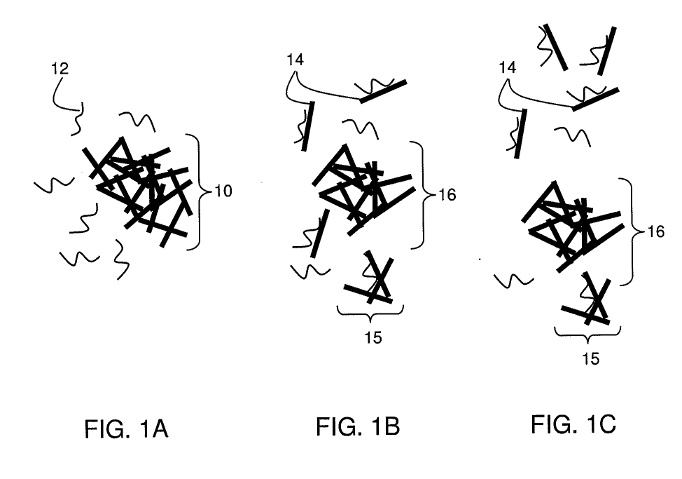

In some embodiments, the method comprises providing a collection of agglomerated nanostructures and exposing a polymer to at least a portion of the agglomerated nanostructures. For example, FIG. 1A includes a schematic illustration of agglomerated nanostructures 10. In this example, a polymer 12 can be exposed to a portion of the agglomerated nanostructures. In some embodiments, exposing the polymer to a portion of the agglomerated nanostructures can comprise adding the polymer to a fluid containing agglomerated nanostructures. Exposing the polymer to a portion of the agglomerated nanostructures can also comprise adding agglomerated nanostructures to a fluid containing the polymer, in some cases. One of ordinary skill in the art will be able to identify other suitable methods for exposing the polymer to the agglomerated nanostructures.

Exposing the polymer to at least a portion of the nanostructures can produce individuated nanostructures and nanostructures that remain agglomerated. For example, as illustrated schematically in FIG. 1B, exposing agglomerated nanostructures 10 to polymer 12 produces individuated nanostructures 14 and nanostructures that remain agglomerated 16. In some cases, the polymer may interact with a nanostructure to produce an individuated nanostructure directly from the original set of agglomerated nanostructures. For example, in FIG. 1B, individuated nanostructures 14 are produced directly from agglomerated nanostructures 10. In some cases, the polymer may interact with the agglomerated nanostructures to produce a plurality of nanostructures in direct contact with each other that are separated from the original set of agglomerated nanostructures. For example, in FIG. 1B, agglomerated nanostructures 15 are produced from the original set of agglomerated nanostructures 10. In some cases, agglomerated nanostructures 15 can be further separated to produce individuated nanostructures. In some embodiments, the production of individuated nanostructures can be assisted, for example, via sonication of the agglomerated nanostructures.

The polymer can, in some instances, serve as a physical barrier between nanostructures such that the nanostructures are not in direct contact with each other. In some embodiments, the polymer does not covalently bond with the nanostructures. The ability to establish a substantially covalent-bond-free interaction can, in some instances, allow the nanostructure to maintain the physical and chemical properties it possesses as an individuated structure. For example, some single-walled carbon nanotubes that are not covalently bonded to another article can exhibit fluorescence.

In some embodiments, the polymer may be capable of participating in a pi-pi interaction with the nanostructures. A pi-pi interaction (a.k.a., “pi-pi stacking”) is a phenomenon known to those of ordinary skill in the art, and generally refers to a stacked arrangement of molecules adopted due to interatomic interactions. Pi-pi interactions can occur, for example, between two aromatic molecules. Pi-pi interactions can occur, in some cases, in the absence of a covalent bond between the interacting molecules. If the polymer comprises relatively large groups, pi-pi interaction can be reduced or eliminated due to steric hindrance. Hence, in certain embodiments, the polymer may be selected or altered such that steric hindrance does not inhibit or prevent pi-pi interactions. One of ordinary skill in the art can determine whether a polymer is capable or participating in pi-pi interactions with a nanostructure.

The polymer may comprise one or more pendant groups. In some embodiments, a pendant group can be capable of participating in a pi-pi interaction with a nanostructure. In some cases, the polymer may comprise an aromatic group which can participate in pi-pi interactions. Examples of suitable aromatic groups include, but are not limited to, aryl groups (e.g., phenyl groups such as phenoxy groups, benzyl groups, tolyl groups, o-xylyl groups, and the like), and fused aromatic rings (e.g., napthalene, anthracene, pyrene, and the like), among others. In some embodiments, the polymer may comprise other functional groups that, while not necessarily capable of participating in pi-pi interactions with the nanostructure, participate in interactions with the nanostructure that lead to improved suspension and/or isolation of the nanostructure. For example, in some cases, the polymer can comprise, for example, alkyl chains (e.g., relatively long alkyl chains with at least about 3, at least about 5, at least about 10, at least about 20, or more carbon atoms), 2-pyrrolidone, pyrrolidine, a nucleobase (e.g., adenine, guanine, thymine, cytosine, uracil, and the like), cyclohexane, cyclopentane, and derivatives or combinations of these.

The pendant groups on the polymer capable of participating in pi-pi interactions may be present in any suitable amount. For example, in some embodiments, the polymer comprises at least about 1 wt %, at least about 2 wt %, at least about 3 wt %, at least about 5 wt %, at least about 7.5 wt %, at least about 10 wt %, or at least about 12 wt % pendant groups capable of participating in pi-pi interactions with a nanostructure (e.g., aromatic groups such as phenoxy groups). In some embodiments, the polymer comprises between about 9 wt % and about 18 wt %, between about 11 wt % and about 16 wt %, or between about 12 wt % and about 14 wt % pendant groups capable of participating in pi-pi interactions with a nanostructure (e.g., aromatic groups such as phenoxy groups).

The polymers described herein may also comprise any suitable molecular weight. In some embodiments, the polymer may have a molecular weight of at least about 10, at least about 25, at least about 50, at least about 100, or at least about 150 kilodaltons (kDa). In some embodiments, the polymer may have a molecular weight of between about 10 kDa and about 500 kDa, between about 25 kDa and about 400 kDa, between about 50 kDa and about 300 kDa, or between about 100 kDa and about 200 kDa.

In some embodiments, at least a portion of the individuated nanostructures can be isolated from the nanostructures that remain agglomerated. In the exemplary embodiments of FIG. 1C, individuated nanostructures 14 have been isolated from agglomerated nanostructures 15 and agglomerated nanostructures 16. In some embodiments, individuated nanostructures can also be isolated from impurities such as, for example, catalysts used to produce the nanostructures, or other impurities. A relatively pure fraction of individuated nanostructures can be isolated, in some cases. In some embodiments, at least about 80 wt %, at least about 90 wt %, at least about 95 wt %, at least about 98 wt %, at least about 99 wt %, or at least about 99.9 wt % of an isolated fraction comprises individuated nanostructures. In some embodiments, an isolated fraction can comprise a relatively large percentage of the individuated nanostructures produced from agglomerated nanostructures. For example, in some embodiments, at least about 20%, at least about 35%, at least about 50%, at least about 65%, at least about 80%, at least about 90%, at least about 95%, at least about 99%, or at least about 99.9% of the individuated nanostructures (e.g., produced from agglomerated nanostructures) can be isolated from nanostructures that remain agglomerated.

Isolating individuated nanostructures from agglomerated nanostructures can be carried out in a variety of ways. In some embodiments, the individuated nanostructures can be isolated based upon differences in mass, for example, via centrifugation. In a typical arrangement involving centrifugation, an object is put in rotation about an axis, resulting in force applied perpendicular to the axis. Particles with relatively larger densities are physically separated from those with relatively smaller densities in this manner, typically within a sample tube. Optionally, the temperature and pressure of the system can be lowered, and the sample can be spun at very high speeds (e.g. 70,000 RPM) as in the case of ultracentrifugation. Other techniques can include sedimentation, application of an electric field (e.g., when the nanostructures are charged), among others.

In some embodiments, it may be advantageous to separate one or more populations of nanostructures using a relatively low relative centrifugal force. For example, individuated nanostructures may be isolated from agglomerated nanostructures, in some cases, without the use of ultracentrifugation. Such low-force centrifuges may be useful, for example, in scaling up the system such that separations may be performed industrially at high volume. In addition, centrifuges that employ relatively low relative centrifugal force are generally less expensive than ultracentrifugation systems. Low-force centrifuges may also, in some cases, allow for the handling of larger amounts of material. In some embodiments, a centrifuge may be operated using a relative centrifugal force of less than about 100,000 g, less than about 10,000 g, less than about 1000 g, less than about 100 g, less than about 10 g, or smaller. In some cases, the centrifuge may operate using a relative centrifugal force of between about 100 g and about 100,000 g, or between about 1000 g and about 10,000 g. In some instances, though, ultracentrifugation can be used to isolate one or more populations of nanostructures. In such embodiments, the relative centrifugal force may be at least about 100,000 g, at least about 1,000,000 g, or higher.

The isolation of individuated nanostructures from agglomerated nanostructures can be achieved, to any suitable level described herein, over a relatively short period of time, in some embodiments. In some cases, individuated nanostructures can be isolated from agglomerated nanostructures (e.g., to produce a fraction comprising at least about 80 wt %, at least about 90 wt %, at least about 95 wt %, at least about 98 wt %, at least about 99 wt %, or at least about 99.9 wt % of the nanostructures) over a time period of less than about 10 hours, less than about 5 hours, or less than about 1 hour.

In some embodiments, the nanostructures and the polymer are contained within a fluid. As used herein, the term “fluid” generally refers to a substance that tends to flow and to conform to the outline of its container. Typically, fluids are materials that are unable to withstand a static shear stress, and when a shear stress is applied, the fluid experiences a continuing and permanent distortion. The fluid may have any suitable viscosity that permits at least some flow of the fluid. Non-limiting examples of fluids include liquids and gases, but may also include free-flowing solid particles (e.g., cells, vesicles, etc.), viscoelastic fluids, and the like. In some embodiments, the fluid may comprise water, chloroform, acetonitrile, N-methylpyrrolidone (NMP), or any other suitable fluid in which nanostructures (e.g., carbon nanotubes) can be suspended. In some embodiments, a fluid may be selected that is capable of forming a stable suspension of semi-conductive nanostructures (e.g., semi-conductive carbon nanotubes).

In some cases, individuated nanostructures may be isolated from agglomerated nanostructures within a first fluid, and at least a portion of the first fluid can be removed to produce a plurality of individuated nanostructures in indirect solid contact. Two articles (e.g., individuated nanostructures) are said to be in “indirect solid contact” with one another when they are not in direct contact with each other, and when a line can be drawn from one article to the other without passing through a non-solid region (e.g., a fluid). Typically, in such a situation, one or more solid materials (e.g., a polymer capable of participating in pi-pi interactions) are positioned between the nanostructures at the point of contact. In some embodiments, the nanostructures can be at least partially surrounded by a solid article (e.g., a polymer). In some cases, these solid articles can themselves be individuated, and/or moveable relative to each other (e.g., defining a powder). In some embodiments, at least about 50%, at least about 75%, at least about 90%, at least about 95%, at least about 99%, or at least about 99.9% of the nanostructures within a plurality of nanostructures from which a fluid has been removed comprise individuated nanostructures. In some embodiments, at least about 90 wt %, at least about 95 wt %, at least about 99 wt %, or at least about 99.9 wt % of the first fluid is removed from the mixture comprising the nanostructures. In some embodiments, substantially all of the first fluid is removed from the mixture comprising the nanostructures forming, for example, a powder comprising individuated nanostructures.

Fluid can be removed from a suspension of nanostructures using any suitable method including, for example, drying, filtering, etc. In one set of embodiments, fluid can be removed via freeze drying. The process of freeze drying an article is known to one of ordinary skill in the art, and generally refers to a process by which fluid is removed from an article by freezing the article and exposing the article to sufficiently low pressures as to cause expedited evaporation and/or sublimation of the fluid from the article. In some cases, essentially all of the fluid removal can occur via sublimation. The ability to freeze dry nanostructures while maintaining their individuated state can be advantageous in some cases. For example, in many cases, freeze-drying process are relatively easy to employ at commercial scales, relative to, for example, process that use heat-based drying or physical separation methods (e.g., filtration). In some embodiments, a relatively large number of individuated nanostructures remain individuated (e.g., at least about 90%, at least about 95%, at least about 99%, or more) after they are subject to a freeze drying process (e.g., to remove a fluid from a suspension of nanostructures). In some cases, the freeze-dried nanostructures may comprise fluorescent nanostructures (e.g., single-walled carbon nanotubes). A mixture comprising fluorescent nanostructures can be freeze dried to produce a plurality of individuated nanostructure in indirect solid contact, wherein the plurality of nanostructures are fluorescent.

In some embodiments, a plurality of nanostructures produced by removing a first fluid from a first suspension of nanostructures (e.g., via freeze drying) may be added to a second fluid. Addition of the nanostructures to the second fluid can produce a suspension comprising individuated nanostructures. In some embodiments, the second fluid may comprise a relatively high number of individuated nanostructures. For example, in some embodiments, fewer than about 8%, fewer than about 5%, fewer than about 2%, fewer than about 1%, fewer than about 0.5%, fewer than about 0.1%, or fewer of the nanostructures in the second fluid are in direct contact with another nanostructure. In some cases, the second fluid can comprise a relatively high number of nanostructures that are not in direct or indirect solid contact with another nanostructure. For example, in some instances, at least about 80%, at least about 90%, at least about 95%, at least about 98%, or at least about 99% of the nanostructures in the second fluid are not in direct contact or in indirect solid contact with another nanostructure.

Re-suspension of a plurality of dried or at least partially dried nanostructures can be achieved, in some cases, via the application of relatively small forces. In some cases, a plurality of dried or at least partially dried nanostructures can be re-suspended in a second fluid without the use of a centrifuge or without the use of sonication. For example, in some embodiments, a plurality of dried or at least partially dried nanostructures can be re-suspended in a second fluid by shaking, by hand, a container comprising the nanostructures (e.g., a container comprising the nanostructures and a fluid). In some embodiments, a plurality of dried or at least partially dried nanostructures can be re-suspended in a second fluid by applying a relative centrifugal force (e.g., via a centrifuge, via hand shaking) of less than about less than about 100 g, less than about 10 g, less than about 1 g, less than about 0.5 g, or less than about 0.1 g. One or ordinary skill in the art would be capable of determining a relative centrifugal force in cases not involving a centrifuge (e.g., in cases where a container is shaken by hand), for example, using the following formula:

g=(1.12×10⁻⁶)(R)(rpm²) [1]

wherein g is expressed as a multiple of g (i.e., in g-forces), R is the radius over which the force is applied measured from the container in which the nanostructures are contained to the axis of rotation (e.g., the distance from a vial containing the nanostructures to a stationary axis such as an elbow or a shoulder) measured in millimeters, and rpm is the speed at which the force is applied measured in revolutions per minute.

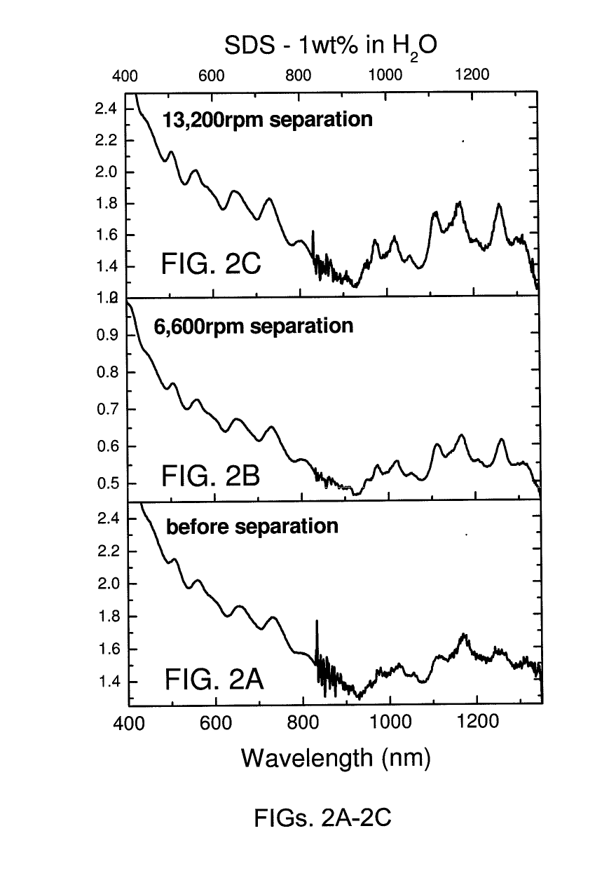

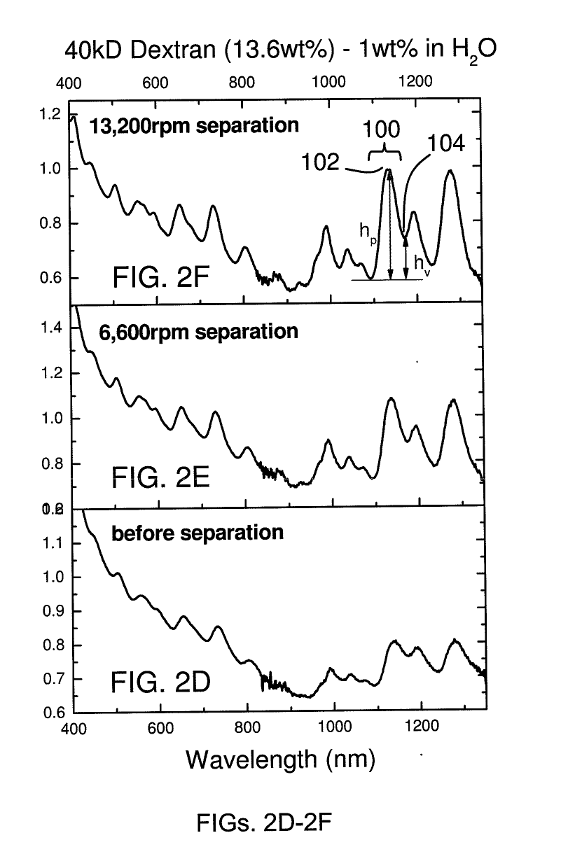

A plurality of nanostructures may exhibit a relatively high fluorescence, in some cases. The plurality of nanostructures exhibiting high fluorescence may comprise, for example, a plurality of suspended nanostructures with a relatively large fraction in neither direct contact nor indirect solid contact, a plurality of nanostructures in indirect solid contact (e.g., in a powder, within a polymeric film, etc.), and the like. In some cases, a photo-absorption spectrum of the plurality of nanostructures can comprise a peak with a relatively high peak maximum-to-valley ratio. In performing the analysis of a peak within an absorption spectrum, the peak maximum corresponds to the maximum absorption within the peak measured relative to the minimum absorption within the peak (generally one of the two sides of the peak). The valley corresponds to the second lowest absorption within the peak (generally on the side of the peak opposite the side corresponding to the peak minimum) and is measured relative to the minimum absorption exhibited within the peak. The peak maximum-to-valley ratio is then calculated by dividing the peak maximum by the valley. An exemplary photo-absorption spectrum is shown in FIG. 2F. The peak maximum-to-valley ratio of peak 100 is calculated by dividing peak maximum 102 by valley 104. In some embodiments, a photo-absorption spectrum of a plurality of nanostructures may comprise a peak with a peak maximum-to-valley ratio of at least about 2.0, at least about 2.5, at least about 3.0, or at least about 3.5. In some embodiments, the tallest peak (with height measured as the distance from the maximum absorption within the peak to the minimum adsorption within the peak) within a photo-absorption spectrum of a plurality of nanostructures can have a peak maximum-to-valley ratio of at least about 2.0, at least about 2.5, at least about 3.0, or at least about 3.5. One of ordinary skill in the art would be capable of determining peak maximum-to-valley ratios by analyzing photo-absorption spectra obtained from, for example, a UV-vis-nIR absorption spectrometer using near-infrared fluorescence.

The systems and methods described herein may be used with a variety of nanostructures. In some embodiments, a nanostructure may have at least one cross-sectional dimension of less than about 500 nm, less than about 250 nm, less than about 100 nm, less than about 75 nm, less than about 50 nm, less than about 25 nm, less than about 10 nm, or, in some cases, less than about 1 nm. In some embodiments, a nanostructure has a maximum cross-sectional dimension of less than about 1 micron, less than about 500 nm, less than about 250 nm, less than about 100 nm, less than about 75 nm, less than about 50 nm, less than about 25 nm, less than about 10 nm, or, in some cases, less than about 1 nm. As used herein, the “maximum cross-sectional dimension” refers to the largest distance between two opposed boundaries of an individual structure that may be measured.

In some embodiments, carbon-based nanostructures are described. As used herein, a “carbon-based nanostructure” comprises a fused network of aromatic rings wherein the nanostructure comprises primarily carbon atoms. In some instances, the nanostructures have a cylindrical, pseudo-cylindrical, or horn shape. A carbon-based nanostructure can comprises a fused network of at least about 10, at least about 50, at least about 100, at least about 1000, or at least about 10,000 aromatic rings. Carbon-based nanostructures may be substantially planar or substantially non-planar, or may comprise a planar or non-planar portion. Carbon-based nanostructures may optionally comprise a border at which the fused network terminates. For example, a sheet of graphene comprises a planar carbon-containing molecule comprising a border at which the fused network terminates, while a carbon nanotube comprises a nonplanar carbon-based nanostructure with borders at either end. In some cases, the border may be substituted with hydrogen atoms. In some cases, the border may be substituted with groups comprising oxygen atoms (e.g., hydroxyl). In other cases, the border may be substituted as described herein.

In some embodiments, the nanostructures described herein may comprise nanotubes. As used herein, the term “nanotube” is given its ordinary meaning in the art and refers to a substantially cylindrical molecule or nanostructure comprising a fused network of primarily six-membered rings (e.g., six-membered aromatic rings). In some cases, nanotubes may resemble a sheet of graphite formed into a seamless cylindrical structure. It should be understood that the nanotube may also comprise rings or lattice structures other than six-membered rings. Typically, at least one end of the nanotube may be capped, i.e., with a curved or nonplanar aromatic group. Nanotubes may have a diameter of the order of nanometers and a length on the order of microns, tens of microns, hundreds of microns, or millimeters, resulting in an aspect ratio greater than 100, 1000, 10,000, or greater. In some embodiments, a nanotube can have a diameter of less than about 1 micron, less than about 500 nm, less than about 250 nm, less than about 100 nm, less than about 75 nm, less than about 50 nm, less than about 25 nm, less than about 10 nm, or, in some cases, less than about 1 nm.

In some embodiments, a nanotube may comprise a carbon nanotube. The term “carbon nanotube” refers to nanotubes comprising primarily carbon atoms. Examples of carbon nanotubes include single-walled carbon nanotubes (SWNTs), double-walled carbon nanotubes (DWNTs), multi-walled carbon nanotubes (MWNTs) (e.g., concentric carbon nanotubes), inorganic derivatives thereof, and the like. In some embodiments, the carbon nanotube is a single-walled carbon nanotube. In some cases, the carbon nanotube is a multi-walled carbon nanotube (e.g., a double-walled carbon nanotube).

In some embodiments, the nanostructures comprise non-carbon nanotubes. Non-carbon nanotubes may be of any of the shapes and dimensions outlined above with respect to carbon nanotubes. The non-carbon nanotube material may be selected from polymer, ceramic, metal and other suitable materials. For example, the non-carbon nanotube may comprise a metal such as Co, Fe, Ni, Mo, Cu, Au, Ag, Pt, Pd, Al, Zn, or alloys of these metals, among others. In some instances, the non-carbon nanotube may be formed of a semi-conductor such as, for example, Si. In some cases, the non-carbon nanotubes may be Group II-VI nanotubes, wherein Group II consists of Zn, Cd, and Hg, and Group VI consists of O, S, Se, Te, and Po. In some embodiments, non-carbon nanotubes may comprise Group III-V nanotubes, wherein Group III consists of B, Al, Ga, In, and Tl, and Group V consists of N, P, As, Sb, and Bi. As a specific example, the non-carbon nanotubes may comprise boron-nitride nanotubes.

In some embodiments, the nanotube may comprise both carbon and another material. For example, in some cases, a multi-walled nanotube may comprise at least one carbon-based wall (e.g., a conventional graphene sheet joined along a vector) and at least one non-carbon wall (e.g., a wall comprising a metal, silicon, boron nitride, etc.). In some embodiments, the carbon-based wall may surround at least one non-carbon wall. In some instances, a non-carbon wall may surround at least one carbon-based wall.

A variety of polymers may be used in association with the embodiments described herein. In some embodiments, the polymer may comprise a polysaccharide such as, for example, dextran, amylose, chitin, and cellulose. In some embodiments, the polymer may comprise a protein. Examples of suitable proteins include, but are not limited to glucose oxidase, bovine serum albumin and alcohol dehydrogenase. The polymer may also comprise a synthetic polymer (e.g., polyvinyl aclohol), in some embodiments.

The following examples are intended to illustrate certain embodiments of the present invention, but do not exemplify the full scope of the invention.

### Example

This example describes the use of phenoxy dextran to produce dispersed and isolated single-walled carbon nanotubes (SWNTs) from agglomerated nanotubes in aqueous solution, according to one set of embodiments. It has been discovered that phenoxy dextran shows a relatively high ability to produce individuated SWNTs from raw materials compared to, for example, sodium dodecyl sulfate (SDS), a surfactant believed to be one of the best SWNT suspension materials known to date. Furthermore, this example demonstrates that agglomerated SWNTs or impurities present in as-produced SWNT mixtures can be separated from individuated SWNTs using relatively mild conditions. For example, a relatively low-energy centrifugation process can be used, replacing a higher energy process that can be difficult and expensive to scale to industrial production levels. The dispersion and isolation described in this example is so effective that the resulting solution can be freeze-dried and stored. Re-dispersion can be achieved by adding water and mildly shaking, eliminating the need for an ultrasonicator or centrifugation step. The extent to which the carbon nanotubes are individuated can be determined by the extent to which they demonstrate photoluminescence (e.g., near-infrared photoluminescence), as aggregates generally do not exhibit photoluminescence, while individuated single-walled nanotubes generally do.

SWNTs and phenoxy-derivatized dextran were suspended in aqueous solution. Sodium dodecyl sulfate (SDS) was used in another SWNT suspension to provide a performance comparison, as SDS is commonly used surfactant to suspend SWNTs. The starting dextran reagents (10, 40, 70, and 150 kD in molecular weight) and sodium dodecyl sulfate (SDS) were obtained from Sigma Aldrich, and the SWNTs were obtained from Nano-C, inc.

Modification of the dextran with hydrophobic moieties was performed to achieve a stable suspension of SWNTs. Dextran (10, 40, 70, 150 kD in molecular weight) was first dissolved in 1M NaOH solution. 1,2-Epoxy-3-phenoxy propane was added to this solution to introduce hydrophobic phenoxy group to the dextran. Reaction was performed at 40° C. for 15 hours, and the resulting product was washed with methanol (MeOH) and water to remove un-reacted reagents. The percentage of phenoxy groups in the polymer was varied from 7.78 to 17 wt % among multiple solutions to investigate the effect of phenoxy group concentration on the ability to suspend SWNTs.

SWNTs suspensions were prepared by adding 1 wt % of phenoxy dextran to water. The SDS comparison suspensions were prepared by adding 1 wt % SDS to water. As-produced SWNTs were suspended in the solutions and ultra-sonicated for 1 hour (10 W). SWNT bundles and metal catalyst impurities were removed via centrifugation (e.g., ultra-centrifugation or bench-top centrifugation (i.e., mild-centrifugation)). The SWNTs were characterized using UV-vis-nIR (Shimadzu) and n-IR fluorescence (Princeton Instruments). The bench-top centrifuge included a rotational radius (R in Equation 1 above) of 45.5 mm, yielding a relative centrifugal force of about 16,100 g for a rotational speed of 13,200 RPM, and a relative centrifugal force of about 153,720 g for a rotational speed of 30,000 RPM.

UV-vis-nIR absorption and n-IR fluorescence were used to produce absorption spectra of various samples to investigate the effectiveness with which SWNTs were suspended. FIGS. 2A-2F include representative UV-vis-nIR absorption spectra of SWNTs suspended with phenoxy dextran (13.6 wt % phenoxy groups and 40 kD MW dextran) and SDS before and after mild-centrifugation. Each absorption peak represents an individual (n,m) SWNT. The intensity and resolution of each peak indicated how well individual SWNTs were suspended. In the case of SDS suspended SWNTs before centrifugation (FIGS. 2A-2C), the intensities and resolutions of the absorption peaks were low due to the low concentration of individuated SWNTs and the presence of aggregated SWNTs and graphitic impurities. Mild-centrifugation (bench-top centrifugation) was performed on this sample for 1 hour to remove aggregated SWNTs. FIG. 2B (6,000 rpm) and FIG. 2C (13,200 rpm) illustrate that the peak intensity and resolution increased as the rotational speed of centrifuge increased. However, the extent of the increase for these samples was minor.

On the other hand, the phenoxy dextran suspended SWNTs (FIGS. 2D-2F), exhibited notable changes in peak intensity and resolution. Initial peak intensity and resolution before centrifugation was much higher than that of SDS-suspended SWNTs, indicating that phenoxy dextran produced a larger amount of individually suspended SWNTs compared to SDS suspended SWNTs. These values further increased after 13,200 rpm centrifugation. These results indicate that phenoxy dextran can disperse individual SWNTs more effectively than SDS. In addition, phenoxy dextran can be used to separate agglomerated SWNTs and impurities using mild-centrifugation, which is a relatively low cost, quick, and commercially scalable process.

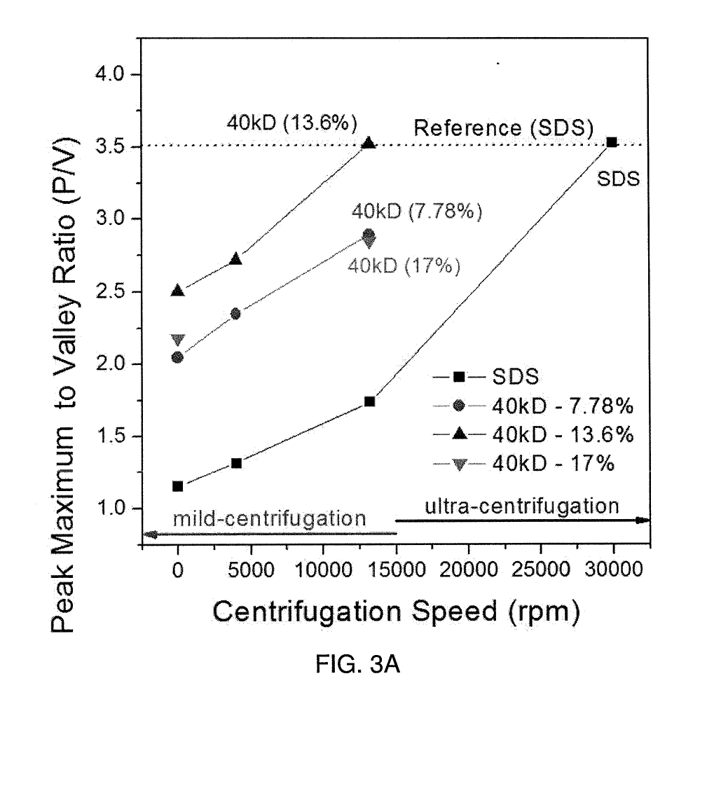

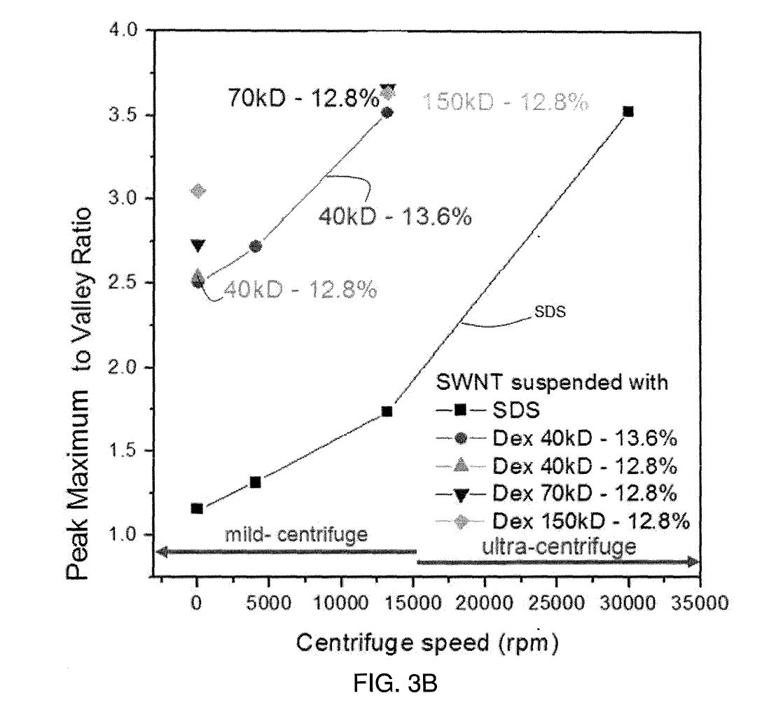

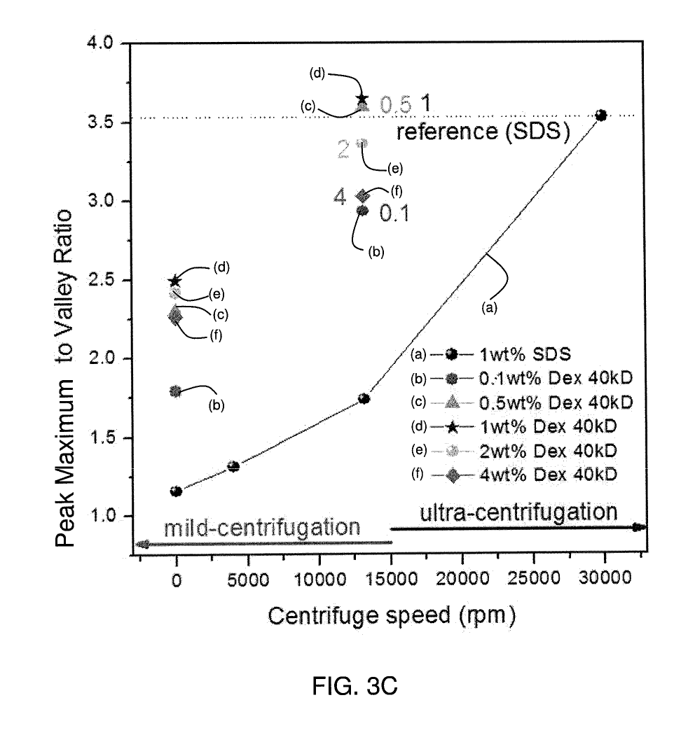

To quantify the effectiveness of phenoxy dextran in producing individuated SWNTs, the peak maximum-to-valley ratio of two adjacent peaks were measured for various SWNT suspensions. This process as illustrated in FIG. 2F, which includes lines indicating the heights at absorption wavelengths of 1133 nm (hₚ) and 1189 nm (hᵥ). The peak maximum-to-valley ratio was calculated as hₚ/hᵥ. The results of these calculations are shown in FIGS. 3A-3C.

Peak maximum-to-valley ratios for different phenoxy group concentrations (about 7.78 wt % to about 17 wt %) were measured, the results of which are illustrated in FIG. 3A. All ratios were compared to the reference sample that included SDS-suspended SWNTs after ultra-centrifugation, a common method in this field. FIG. 3A illustrates that a phenoxy group content of about 13.6 wt % produced the most effective suspension of the concentrations tested. After sonication, but before centrifugation, the peak maximum-to-valley ratio for the phenoxy dextran-suspended samples were much higher than that of the SDS-suspended sample, indicating that phenoxy dextran can be more effective in producing large amounts of individuated SWNTs than SDS. Moreover, the peak maximum-to-valley ratio of phenoxy dextran-suspended sample after 13,200 rpm mild-centrifugation was similar to that of the SDS-suspended SWNTs after 30,000 rpm ultra-centrifugation for 4 hours. This result indicates that phenoxy dextran can produce individuated SWNTs using commercially scalable mild-centrifugation, rather than ultracentrifugation.

The effect of the length (i.e., molecular weight) of the dextran on the ability to produce individuated SWNTs was also investigated. FIG. 3B includes a plot of peak maximum-to-valley ratios as a function of centrifugation speed for SWNT suspensions including phenoxy dextran with varying dextran molecular weights. FIG. 3B shows that, generally, the suspensions including relatively long dextran chains exhibited higher peak maximum-to-valley ratios relative to the suspensions including relatively short dextran chains.

The effect of the concentration of phenoxy dextran the suspension was also investigated. FIG. 3C includes a plot of peak maximum-to-valley ratios as a function of centrifugation speed for SWNT suspensions including phenoxy dextran with varying dextran weight percentages. FIG. 3C illustrates that 0.5 wt % phenoxy dextran in water was sufficient to effectively produce individuated SWNTs.

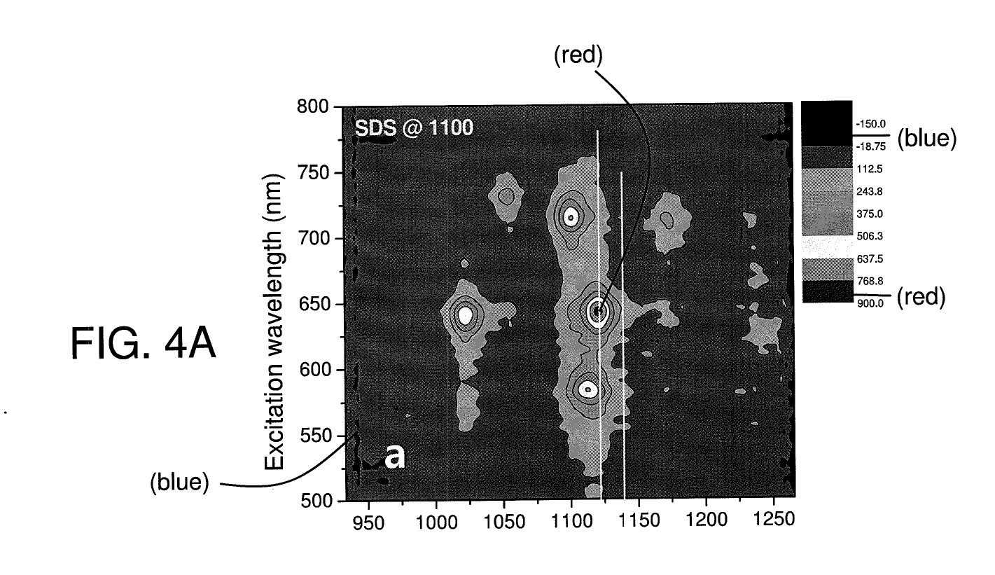

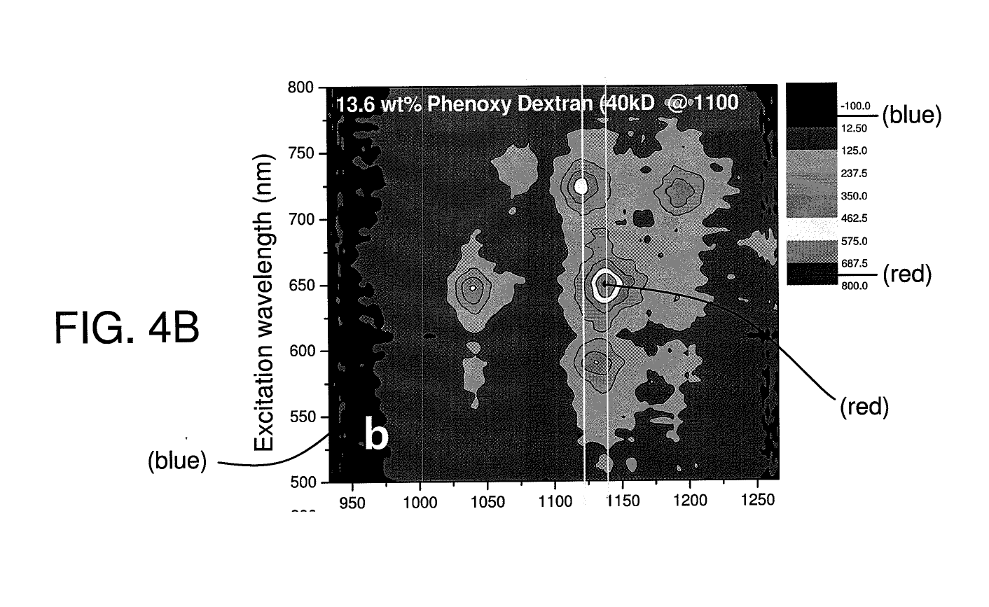

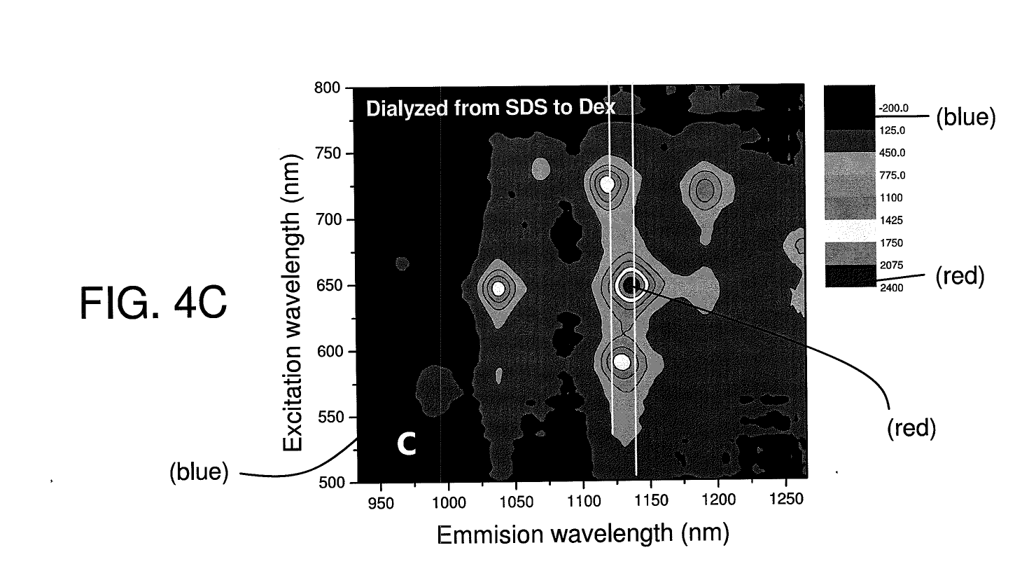

To verify that the generated SWNT species were similar to each other, the photoluminescence (PL) spectra of each sample was measured. FIG. 4A includes a PL spectra of SDS-suspended SWNT after ultra-centrifugation, used as a reference. This sample was dialyzed to exchange the suspension agent (from SDS to 13.6 wt % phenoxy dextran), and the result is shown in FIG. 4B. FIGS. 4A and 4B are very similar, with the exception of a red-shift of fluorescence emission peaks for the dialyzed sample compared to the SDS-suspended SWNTs. The red-shift was expected due to the change in the suspension agent. FIG. 4C shows the PL spectrum of the 13.6 wt % phenoxy dextran-suspended SWNTs after mild-centrifugation. The PL spectrum of this sample is also very similar to that of the dialyzed sample (FIG. 4B), indicating that phenoxy dextran produced similar individuated SWNT species compared to those produced using SDS after ultra-centrifugation.

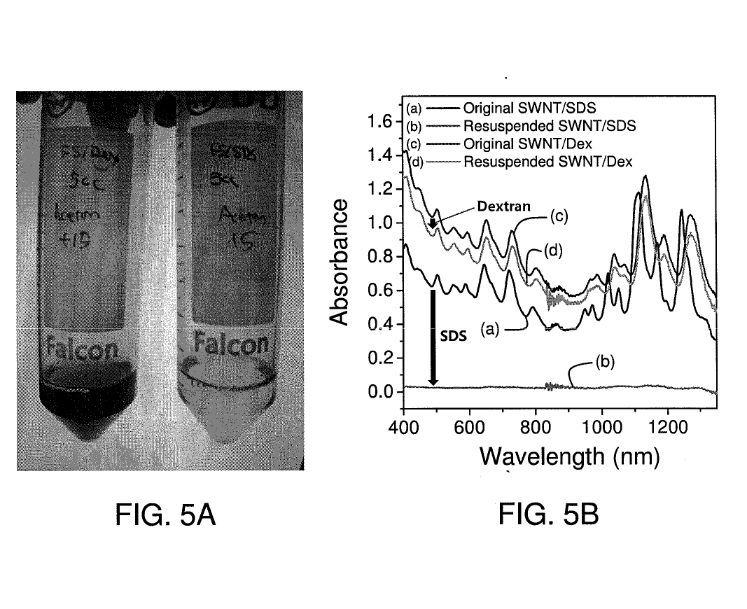

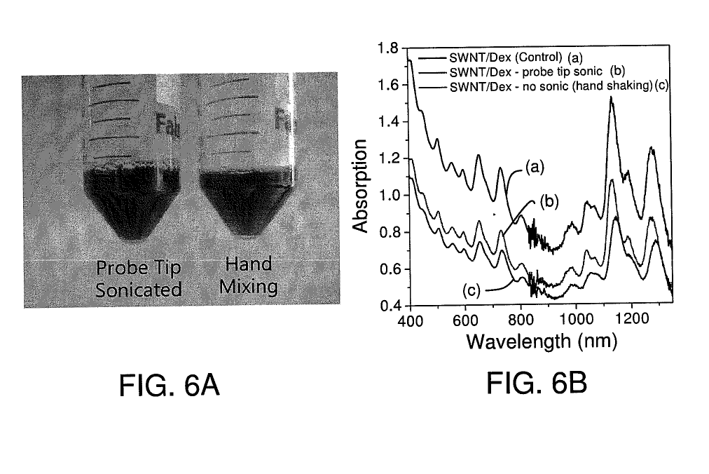

The ability to dry and re-suspend SWNT samples was also investigated. SWNTs usually form aggregated bundles when they are dried, after which they may be difficult to re-suspended (e.g., in water). SWNT samples suspended in phenoxy dextran and SDS were freeze dried for 3 days and collected as a solid. The samples were then re-suspended in water using either probe tip sonication or hand-shaking. Pictures and UV-vis-nIR absorption spectra of the re-suspended SWNT suspensions are shown in FIGS. 5-6. FIGS. 5A-5B include (A) pictures and (B) UV-vis-nIR spectra of re-suspended SWNTs samples after probe-tip sonication. FIGS. 5A-5B illustrate that phenoxy dextran SWNTs could be essentially completely re-suspended in water following probe tip sonication (30 minutes, 10 W). SDS-suspended SWNTs, on the other hand, were not readily re-suspended in water. These results illustrate that phenoxy dextran can be capable of producing individuated SWNTs that can maintain their state of separation, even in a solid state.

In addition, the ease with which the freeze-dried SWNTs can be re-suspended was also investigated. FIGS. 6A-6B include comparative (A) pictures and (B) UV-vis-nIR spectra of phenoxy dextran-SWNTs samples re-suspended by probe tip sonication and hand-shaking FIGS. 6A-6B confirm that hand-shaking can be used to re-suspend freeze-dried SWNTs in water to a similar extent as might be seen using sonication. The ability to re-suspend SWNTs using such small forces may greatly increase the commercial appeal of such nanostructures.

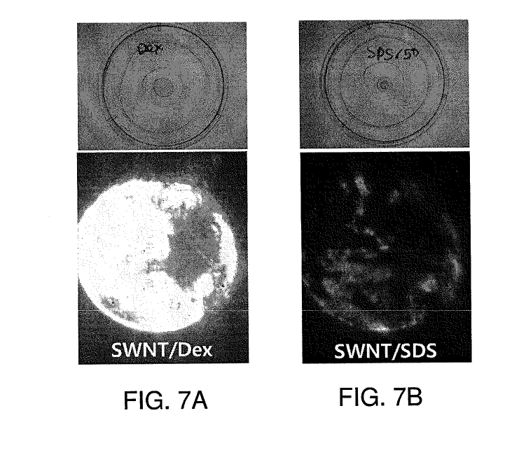

Finally, fluorescent SWNTs were suspended in phenoxy dextran (with comparative samples suspended in SDS) and made into a film by a drop-drying process. The fluorescence of the films was investigated using fluorescent images. FIGS. 7A-7B include fluorescent images of SWNTs suspended in (A) phenoxy dextran and (B) SDS when excited by a 658-nm laser. The phenoxy dextran-SWNT films fluoresced even though they were in the solid state, suggesting that the SWNTs were preserved in an individuated state. The SDS-SWNTs films, on the other hand, showed little measurable fluorescence.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of isolating individuated nanostructures, comprising:
providing a collection of agglomerated nanostructures;
exposing a polymer capable of participating in a pi-pi interaction with the nanostructures to at least a portion of the agglomerated nanostructures to produce individuated nanostructures and nanostructures that remain agglomerated; and
isolating at least a portion of the individuated nanostructures from the nanostructures that remain agglomerated without the use of ultracentrifugation.

2. The method of claim 1, wherein the polymer comprises a phenoxy group.

3. The method of claim 2, wherein the polymer comprises at least about 1 wt % phenoxy groups.

4. The method of claim 2, wherein the polymer comprises between about 9 wt % and about 18 wt % phenoxy groups.

5. The method of claim 2, wherein the polymer comprises between about 11 wt % and about 16 wt % phenoxy groups.

6. The method of claim 2, wherein the polymer comprises between about 12 wt % and about 14 wt % phenoxy groups.

7. The method of claim 1, wherein the polymer comprises dextran.

8. The method of claim 1, wherein the nanostructures comprise carbon-based nanostructures.

9. The method of claim 8, wherein the carbon-based nanostructures comprise carbon nanotubes.

10. The method of claim 9, wherein the carbon nanotubes comprise single-walled carbon nanotubes.

11. The method of claim 9, wherein the carbon nanotubes comprise multi-walled carbon nanotubes.

12. The method of claim 1, wherein the nanostructures comprise nanotubes.

13. The method of claim 1, wherein the nanostructures comprise non-carbon nanotubes.

14. The method of claim 1, wherein the collection of agglomerated carbon nanostructures is provided as a mixture in a liquid.

15. The method of claim 14, wherein the liquid comprises water.

16. The method of claim 14, further comprising freeze drying the mixture.

17. The method of claim 1, wherein isolating at least a portion of the individuated nanostructures comprises using a centrifuge with a relative centrifugal force of less than about 100,000 g.

18. The method of claim 1, wherein isolating at least a portion of the individuated nanostructures comprises using a centrifuge with a relative centrifugal force of less than about 10,000 g.

19. The method of claim 1, wherein isolating at least a portion of the individuated nanostructures comprises using a centrifuge with a relative centrifugal force of less than about 1000 g.

20. The method of claim 1, wherein isolating at least a portion of the individuated nanostructures comprises using a centrifuge with a relative centrifugal force of less than about 100 g.

21. A method of isolating individuated nanostructures, comprising:
providing a collection of agglomerated nanostructures;
exposing a polymer capable of interacting with the nanostructures to at least a portion of the agglomerated nanostructures to produce individuated nanostructures and nanostructures that remain agglomerated; and
isolating at least 20% of the individuated nanostructures from the nanostructures that remain agglomerated without the use of ultracentrifugation.

22. The method of claim 21, wherein the polymer is capable of participating in a pi-pi interaction with the nanostructures.

23. A method, comprising:
providing a mixture comprising a fluid and fluorescent nanostructures; and
freeze drying the mixture to produce a plurality of individuated nanostructures in indirect solid contact, wherein the individuated nanostructures are fluorescent.

24. The method of claim 23, wherein the mixture further comprises a polymer capable of participating in a pi-pi interaction.

25. The method of claim 24, wherein the polymer comprises a phenoxy group.

26. The method of claim 25, wherein the polymer comprises between about 9 wt % and about 18 wt % phenoxy groups.

27. The method of claim 24, wherein the polymer comprises dextran.

28. The method of claim 23, wherein the nanostructures comprise carbon-based nanostructures.

29. The method of claim 28, wherein the carbon-based nanostructures comprise carbon nanotubes.

30. The method of claim 29, wherein the carbon nanotubes comprise single-walled carbon nanotubes.

31. The method of claim 29, wherein the carbon nanotubes comprise multi-walled carbon nanotubes.

32. The method of claim 23, wherein the nanostructures comprise nanotubes.

33. The method of claim 23, wherein the nanostructures comprise non-carbon nanotubes.

34. A method, comprising:
providing a mixture comprising a first fluid and nanostructures;
removing at least about 90 wt % of the first fluid from the mixture to produce a plurality of individuated nanostructures in indirect solid contact; and
adding the individuated nanostructures in indirect solid contact to a second fluid such that less than about 8% of the nanostructures in the second fluid are in direct contact with another nanostructure.

35. The method of claim 34, wherein the mixture further comprises a polymer capable of participating in a pi-pi interaction.

36. The method of claim 34, wherein the polymer comprises a phenoxy group.

37. The method of claim 36, wherein the polymer comprises between about 9 wt % and about 18 wt % phenoxy groups.

38. The method of claim 35, wherein the polymer comprises dextran.

39. The method of claim 34, wherein the fluid comprises water.

40. The method of claim 34, wherein the removing step comprises removing at least about 95 wt % of the first fluid.

41. The method of claim 34, wherein the removing step comprises removing at least about 99 wt % of the first fluid.

42. The method of claim 34, wherein the removing step comprises removing at least about 99.9 wt % of the first fluid.

43. The method of claim 34, wherein the removing step comprises removing substantially all of the first fluid.

44. The method of claim 34, wherein the nanostructures comprise carbon-based nanostructures.

45. The method of claim 44, wherein the carbon-based nanostructures comprise carbon nanotubes.

46. The method of claim 45, wherein the carbon nanotubes comprise single-walled carbon nanotubes.

47. The method of claim 46, wherein the carbon nanotubes comprise multi-walled carbon nanotubes.

48. The method of claim 34, wherein the nanostructures comprise nanotubes.

49. The method of claim 34, wherein the nanostructures comprise non-carbon nanotubes.
